(19) United States
(12) Patent Application Publication
(10) Pub. No.: US 2018/0253414 A1
(43) Pub. Date: Sep. 6, 2018

(54) DETERMINING OUTPUT PRESENTATION TYPE

(71) Applicant: ENTIT Software LLC, Sunnyvale, CA (US)

(72) Inventors: Joshua Hailpern, Sunnyvale, CA (US); David Matslofva, Sunnyvale, CA (US)

(73) Assignee: ENTIT Software LLC, Sunnyvale, CA (US)

(21) Appl. No.: 15/760,521

(22) PCT Filed: Sep. 19, 2015
(86) PCT No.: PCT/US2015/051109

§ 371 Date: Mar. 15, 2018

(51) Int. Cl. G06F 17/24; G06F 3/0486; G06F 17/21; G06T 11/20

(52) U.S. Cl. CPC G06F 17/246; G06T 11/203; G06F 17/211; G06F 3/0486

(57) ABSTRACT

Examples relate to determining output presentation type. In one example, a computing device may: receive first input indicating selection of a first data set from a source file; receive second input indicating selection of a second data set from the source file; determine, based on at least one feature of the first data set and second data set, an output presentation type for output data; and cause presentation of the output data according to the output presentation type.

### BACKGROUND

Using computers and other similar devices, many different types of data may be presented in a variety of ways. Typical computer applications used to manage data may present the data as it was input by a user or other computing device. For example, a spreadsheet application may present data in rows and columns as a user fills in the data.

### BRIEF DESCRIPTION OF THE DRAWINGS

The following detailed description references the drawings, wherein:

FIG. 1 is a block diagram of an example computing device for determining output presentation type.

FIG. 2 is an example data flow for determining output presentation type.

FIG. 3 is an illustration of an example spreadsheet application in which output presentation type is determined.

FIG. 4 is a flowchart of an example method for determining output presentation type.

### DETAILED DESCRIPTION

The ability to determine the manner in which data is presented may facilitate the informational needs of the users and/or devices that handle the data. In some situations, for example, patterns and other characteristics may be identified for multiple data inputs, and information relevant to the data inputs may be presented for consumption by a user and/or computing device. The manner in which the relevant information is presented may depend upon the patterns and/or characteristics of the input.

By way of example, a spreadsheet application may include a variety of entries for customer surveys, where each row of the spreadsheet includes one column for a date of the survey and, for each question included in the survey, a column for a value representing the customer's response in the corresponding survey. An output presentation device may receive selections of some or all of the customer survey data and, depending on characteristics of the selection of data, produce an output for information relevant to the particular selection of customer survey data.

For example, a user may select i) the first column of data that includes values indicating customers' responses to the first question of the survey, and ii) the second column of data that includes values indicating customers' responses to the second question of the survey. These selections may be provided, as input, to the output presentation device. The output presentation device may determine, based on characteristics of the values included in the selected data, to present the user with an average value for each column selected. In this example, each average value would indicate the average of the values provided in response to the corresponding question of the customer survey.

While the foregoing example presented the average, or mean, of selected data, the output presentation device may present output data in a variety of ways. For example, the median, mode, sum, and/or difference in values may be presented, e.g., instead of or in addition to the mean/average. The output presentation device may determine how to present data based on a variety of characteristics. For example, the output presentation device may present a mean for selections of data having a normal distribution, and median for selections of data with a Poisson distribution. In some implementations, the types of values selected, e.g., digits, characters, words, dates, times, etc., may also be used to determine how data is presented. Patterns in the selected data may, in some implementations, also be used to determine the manner in which data is presented. Instead of or in addition to mathematical results, output may be represented in other ways, such as clustering analytics results and/or display a graph or chart. Further details regarding the determination of output presentation type are described in the paragraphs that follow.

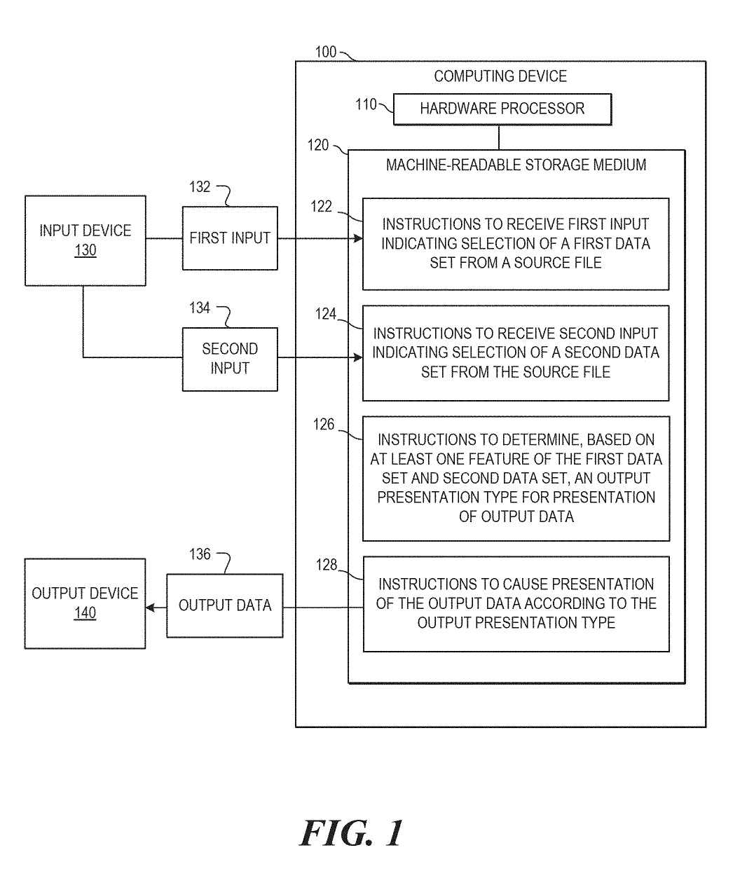

Referring now to the drawings, FIG. 1 is a block diagram of an example computing device 100 for determining output presentation type. Computing device 100 may be, for example, a server computer, a personal computer, a mobile computing device, or any other electronic device suitable for processing data. In the embodiment of FIG. 1, computing device 100 includes hardware processor 110 and machine-readable storage medium 120.

Hardware processor 110 may be one or more central processing units (CPUs), semiconductor-based microprocessors, and/or other hardware devices suitable for retrieval and execution of instructions stored in machine-readable storage medium 120. Hardware processor 110 may fetch, decode, and execute instructions, such as 122-128, to control the process for determining output presentation type. As an alternative or in addition to retrieving and executing instructions, hardware processor 110 may include one or more electronic circuits that include electronic components for performing the functionality of one or more instructions.

A machine-readable storage medium, such as 120, may be any electronic, magnetic, optical, or other physical storage device that contains or stores executable instructions. Thus, machine-readable storage medium 120 may be, for example, Random Access Memory (RAM), an Electrically Erasable Programmable Read-Only Memory (EEPROM), a storage device, an optical disc, and the like. In some implementations, storage medium 120 may be a non-transitory storage medium, where the term “non-transitory” does not encompass transitory propagating signals. As described in detail below, machine-readable storage medium 120 may be encoded with a series of executable instructions: 122-128, for determining output presentation type.

Input device 130 may be any device for handling input received from a user and/or other computing device. For example, input device 130 may process user input received from a keyboard, mouse, microphone, resistive or capacitive touch-screen, or other input data provided by a separate computing device. While the input device 130 is depicted separately from the computing device 100, in some implementations, the input device 130 may be included in the computing device 100.

Output device 140 may be any device for displaying or causing display of data provided by the computing device 100. For example, output device 140 may be a computer monitor, mobile computing device screen, video card display driver, computer application, or other device for displaying or causing the display of data provided by the computing device. While the output device 140 is depicted separately from the computing device 100, in some implementations the input device may be included in the computing device 100.

As shown in FIG. 1, the computing device 100 executes instructions 122 to receive first input 132 indicating selection of a first data set from a source file. For example, a source file may be a spreadsheet that includes data regarding customer surveys. Each row of the spreadsheet may correspond to a distinct customer survey, and each column of the spreadsheet includes data that corresponds to the surveys, such as the date of the survey, subject of the survey, and answers to questions included in the survey. The first input 132 may be, for example, a user's selection of a particular value, column, or row of the spreadsheet, and the first data set may include the data included in the selected column, row, or the particular value.

The computing device 100 executes instructions 124 to receive second input 134 indicating selection of a second data set from the source file. As with the example, above, the second input 134 may be, for example, a user's selection of a different value, column, or row of the spreadsheet, and the second data set may include the data included in the selected column, row, or the particular value.

Using the customer survey example, the first input 132 may be a selection of a column that includes, for each survey, the name of a service or product to which the survey corresponds. The second input 134 may be a selection of another column that includes, for each survey, textual feedback indicating a customer's opinion of the service or product to which the survey corresponds.

In some implementations, the second input 134 may be a particular type of input, e.g., a click and drag of a mouse, a keyboard key combined with a mouse click or clicks, a pinch gesture on a touchscreen, or a variety of other types of input. The particular type of input may, in some implementations, trigger the computing device 100 to determine the manner in which output should be presented for the selected input.

The computing device 100 executes instructions 126 to determine, based on at least one feature of the first data set and second data set, an output presentation type for presentation of output data 136. The at least one feature may include, for example, one feature included in both data sets, one feature from each selected data set, multiple features of both data sets, and/or multiple features of each selected data set.

In some implementations, the feature(s) include a distribution type, pattern type, and/or value type associated with one or both selected data sets. The distribution type feature may, for example, represent the type of distribution, such as a normal distribution, Poisson distribution, long tail distribution, binomial distribution, or no distribution. The pattern type feature may, for example, represent patterns identified in one or both selected data sets, such as monotonically increasing values, frequently repeated characters, frequently repeated n-grams, and/or correlations between values of different data sets. The value type feature may, for example, represent the type of values included in the data sets, such as digits, characters, words, sentences, dates, times, or currency. Other types of distributions, patterns, and values may be used, instead of or in addition to the examples provided above, to determine the manner in which output data 136 is to be represented.

The output presentation type may be one or more of a variety of presentation types. In some implementations, the output presentation type may be a graph or chart, a mathematical result, or a clustering of values, to name a few. A graph or chart presentation may include, for example, representations of selected data in a line graph, histogram, or pie chart. A mathematical result presentation may include, for example, a sum, mean, median, mode, or difference in values of the selected data sets. A clustering presentation is one example of an analytical result, which may include a variety of analytical results, such as bucketing values, clustering the same or similar values, and identifying correlations between values in disparate data sets. Other types of charts and/or graphs, mathematical results, and analytical results may be used, instead of or in addition to the examples provided above, to represent the output data 136.

The manner in which the computing device 100 determines which output presentation type to choose for the given input may vary. In some implementations, the feature(s) or combination of features of the selected data sets may correspond to particular presentation types. By way of example, input data sets that include a textual data type may have output that is mapped to or more likely to be represented in a chart or clustering of the input data. In the customer survey example above, the first data set, e.g., the names of the products or services being reviewed, may include character strings that are frequently repeated. The second data, e.g., the written review of the product or service, may be larger character strings that are mostly unique but share similar keywords, e.g., “good,” “bad,” “great,” “too expensive,” “reasonably priced,” etc. Given the foregoing features of the first and second data set, the computing device 100 may determine, for example, that output data 136 should include, for each unique product or service, a count of keywords identified for the product or service; e.g., Product A: keyword A (count X), keyword B (count Y), keyword C (count Z).

In some implementations, the computing device 100 may use one or more characteristics of the user input to determine which output presentation type is to be used for the output data 136. For example, in situations where particular types of input are used, e.g., keyboard key and mouse click combinations, each particular type of input may correspond to a particular output presentation type. For example, a Shift+click and drag to select data sets may produce a mathematical result, while an Alt+click and drag to select data sets may produce a graph or chart result. In some implementations, the computing device 100 may prompt a user for input to determine which output presentation type to use. For example, a spreadsheet application may include a pop-up dialogue allowing the user to select the output presentation type, e.g., from a drop-down list. In situations where user input is used, the computing device 100 may suggest one or more output presentation types, e.g., by determining one or more output presentation types in the manner described above.

In some implementations, the second input 134 also indicates selection of at least one other data set. In this situation, at least three data sets are selected, and the determination of the output presentation type is further determined based on the additional data sets. Using the customer survey example, an additional column may be selected, the additional column including a timestamp that indicates the date on which the corresponding product or service was surveyed. The computing device 100, upon identifying dates, may determine that the output presentation type should include time-based buckets for the aforementioned count of keywords for each product or service, e.g., such that the output represents, for multiple periods of time, the product/service and keywords identified in customer surveys during that period of time.

The computing device 100 executes instructions 128 to cause presentation of the output data 136 according to the output presentation type. In the example shown in FIG. 1, the computing device 100 provides the output data 136 to the output device 140, e.g., with instructions to display the output data on a screen or particular application location. For example, the instructions may cause the customer survey keyword information to replace the selected data sets or be placed in a separate portion of the spreadsheet, e.g., a portion previously selected by the user. The instructions provided by the computing device 100 may cause display of the output data 136 in a variety of other ways. Further details regarding the determination of output presentation type, and the manner in which output is displayed, are provided in the paragraphs that follow.

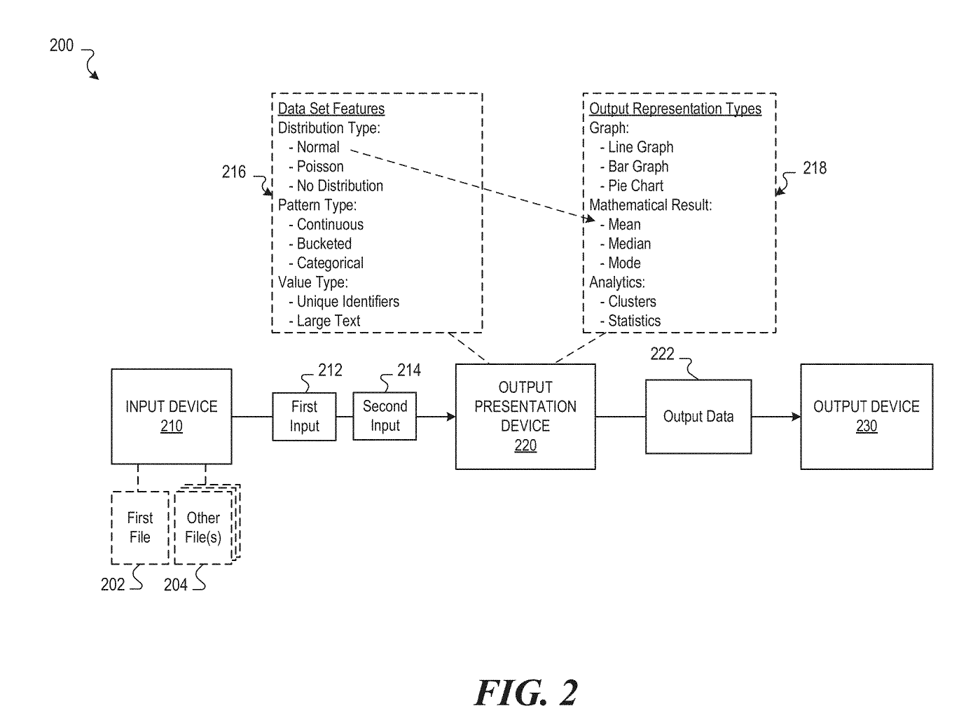

FIG. 2 is an example data flow 200 for determining output presentation type. The data flow 200 depicts various data set features 216 and output presentation types 218 that may be selected by an output presentation device 220, which may be implemented by a computing device, such as the computing device 100 described above with respect to FIG. 1. The input device 210 may be any device capable of handling input, such as the input device 130 described above with respect to FIG. 1. The output device 230 may be any device capable of producing output, e.g., on a computer screen and/or within a computer application, such as the output device 140 described above with respect to FIG. 1.

The input device 210 provides first input 212 and second input 214 to the output presentation device 220. The first input 212 may indicate selection of a first data set from a first file 202 of a particular type, while the second input 214 may indicate selection of at least one other data set from at least one other file 204 of the same file type. For example, the first input 212 may be a selection of a column of a spreadsheet, and the second input 214 may be a selection of a column of a different spreadsheet. E.g., the first data set may be a set of temperature measurements from a first spreadsheet, while another data set includes a set of temperature measurements from a second spreadsheet. In this example, multiple data sets of multiple data types may be selected from multiple spreadsheets.

The output presentation device 220 determines, based on at least one feature associated with the first data set and each of the other data sets, an output presentation type for output data 222. The example data flow 200 includes example data set features 216 that may be used by the output presentation device 220. Each of the data set features 216, and/or combinations of the features, may, in some implementations, be mapped to one or more of the output presentation types 218. In the example data flow 200, an arrow depicts a mapping between a normal distribution type and a mean mathematical result, indicating that data having a normal distribution may lead to calculation of the mean of the selected data sets as an output presentation type.

By way of example, using the temperature measurement example, each spreadsheet may include 12 temperature measurements for a particular city throughout the day, and each selected column may include the 12 measurements taken for that city on a particular day. When the output presentation device 220 analyzes the data sets indicated by the first and second input, it may determine that the temperature values have a normal distribution. In this example, the output presentation device may determine, based on the data having a normal distribution, that the output data 222 should cause display of the mean temperature for each of the 12 temperature measurements across each selected column.

The output device 230, in response to receiving the output data 222, may cause display of the output data 222. In the example above, the output data 222 may be a column that includes, for each of its 12 rows, a mean temperature for each of the cities.

As noted above, many variations may be used when determining the manner in which output data is to be represented. For example, the first and second input may be selections of data from the same file, or even selections from the same row or column or a spreadsheet, e.g., where each set of data includes one value. In addition, the manner in which the inputs are provided may cause output data to be represented in a particular way. For example, certain key combinations and/or gesture inputs may result in selection of a particular presentation type, e.g., allowing the user to select a graph, mathematical result, or analytical result. In some implementations, the output presentation device 220 may present a user with options to select which presentation type(s) should be used. E.g., using the city temperature example, in a situation where an additional column that includes a timestamp is selected for each city, the output presentation device 220 may present a user with the options to display i) the mean temperature over time as a column of data, ii) the mean temperature over time as a line graph, and/or iii) a line graph that includes, for each city, a line that indicates the temperature over time.

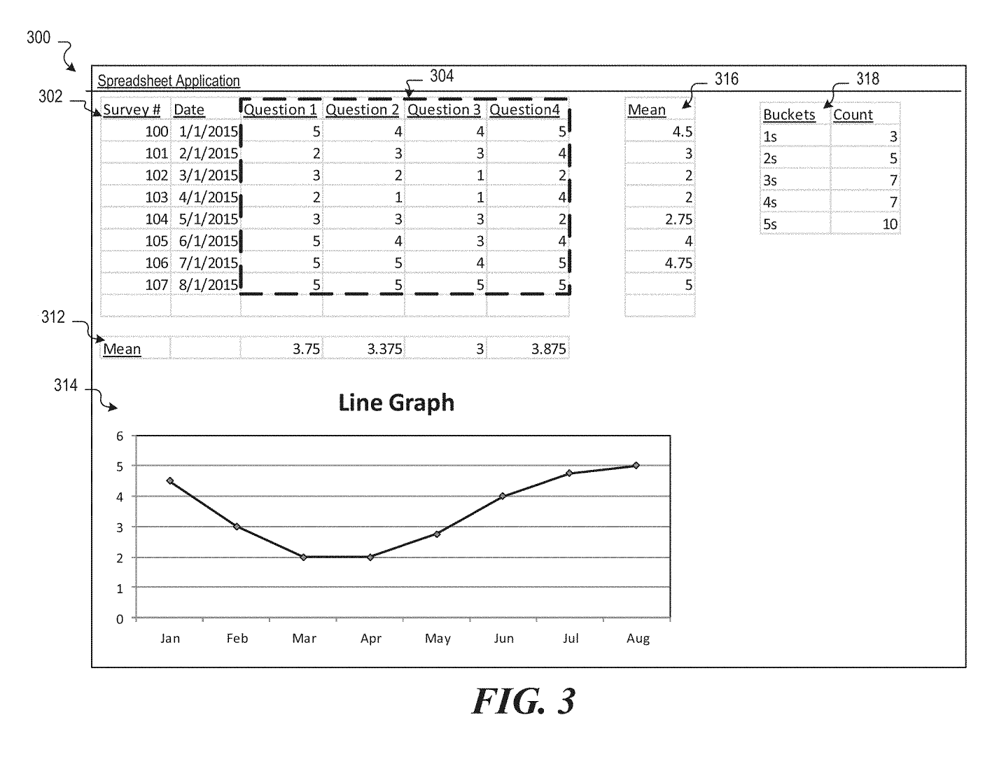

FIG. 3 is an illustration of an example spreadsheet application 300 in which output presentation type is determined. The example includes a spreadsheet 302 that includes data regarding customer surveys. Each row represents a customer survey, and each row has a column for a survey number, a column for the date of the survey, and four columns for answer values for each of four questions.

Several examples of output data are depicted for various selections of data sets included in the spreadsheet 302. Box 304 indicates selection of first and second input data, e.g., a user may select the box including “Question 1” and drag a cursor to the column for “Question 4” or the bottom of the column for “Question 4.” An output presentation device may determine, based on the selected data sets and using methods similar to those described above, that the output should be a mean for each column, or question of the survey, as depicted in the mean row 312. For example, the determination may be made based on the inclusion of each column header in the selection of data, a user's selection based on a prompt provided by the output presentation device, and/or characteristics of the user's input when selecting the input data, e.g., key combination or direction of dragging.

The line graph 314 is an example output that may result from the inclusion of the “Date” column in the data selection. For example, based on the inclusion of date values, the output presentation device may determine that the selected values should be output as a plot of mean values over time.

The mean column 316 includes the mean of the question values for each customer survey. The output presentation device may produce this output, for example, based on the selection of the question values without the question column headers. The bucket count 318 is another example type of output that may be provided by the output presentation device. The bucket count 318 includes a count column indicating the number of times each bucket value occurred in the selected data sets.

In some implementations, an output presentation device may cause display of multiple output data sets. For example, the output presentation device may be configured to cause display of both the mean row 312 and mean column 316. In some implementations, the output data replaces at least a portion of the first or second data sets. For example, in response to selecting the four question columns, e.g., by a click and drag on the column headers, the four question columns may be collapsed into a single column, such as the mean column 316.

In some implementations, the first data set and each other selected data set include a single value. For example, a user may select the first value under the “Question 1” header and drag to the bottom value in the column. In this situation, each cell of the spreadsheet may be treated as a different data set, and the output presentation device may produce output based on features of the data included in the selected cells, such as the mean of the selected values.

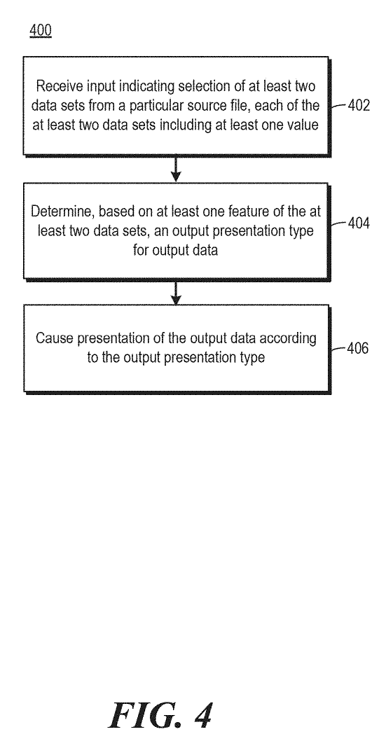

FIG. 4 is a flowchart of an example method 400 for determining output presentation type. The method 400 may be performed by a computing device, such as a computing device described in FIG. 1. Other computing devices may also be used to execute method 400. Method 400 may be implemented in the form of executable instructions stored on a machine-readable storage medium, such as the storage medium 120, and/or in the form of electronic circuitry, such as a field-programmable gate array (FPGA) and/or an application-specific integrated circuit (ASIC). Combinations of one or more of the foregoing processors may also be used to identify randomly generated character strings.

Input indicating selection of data sets from a particular source file is received, each of the data sets including at least one value (402). For example, a user may click and drag to select several rows of a spreadsheet that includes statistics for baseball players, such as player at bats, hits, walks, strike-outs, etc.

Based on at least one feature of the data sets, an output presentation type is determined for output data (404). For example, player hits may be included in one column and represented by an integer value that varies from 0 to 6. Based on the distribution of the values, it may be determined that a sum of the integer values should be presented for that column. In some implementations, different columns of the selected row may be presented differently, e.g., the output presentation type for a different column with a slugging percentage values may be a mean of slugging percentage values.

As indicated in the example above, in some implementations, the feature(s) upon which the output presentation type determination is based may be a distribution type feature, a pattern type feature, and/or a value type feature. In some implementations, the output presentation type includes a graph or chart, a mathematical result, or an analytical result, such as a clustering or bucketing of values. For example, selection of baseball statistics for singles, doubles, triples, and home runs may be presented in a bucket, including a count of each value for each type of hit. This presentation type may be determined automatically by the output presentation device based on characteristics of the data and/or by a user preference or selection of an output presentation type.

The output data is presented according to the output presentation type (406). For example, in response to determining that output for selected rows of a baseball statistics spreadsheet should include a sum of the values in the selected data sets, an output presentation device may cause the spreadsheet application to present the sum of values in a new row of the spreadsheet, or to replace the selected rows of the spreadsheet.

The foregoing disclosure describes a number of example implementations for determining output presentation type. As detailed above, examples provide a mechanism for presenting output in a particular manner based on features identified in input data and potential applications of a system that is capable of determining output presentation type(s).

We claim:

1. A non-transitory machine-readable storage medium encoded with instructions executable by a hardware processor of a computing device for determining output presentation type, the machine-readable storage medium comprising instructions to cause the hardware processor to:
receive first input indicating selection of a first data set from a source file;
receive second input indicating selection of a second data set from the source file;
determine, based on at least one feature of the first data set and second data set, an output presentation type for output data; and
cause presentation of the output data according to the output presentation type.

2. The storage medium of claim 1, wherein:
the second input further indicates a selection of at least one other data set; and
the output presentation type is determined based on the at least one other data set.

3. The storage medium of claim 1, wherein the at least one feature of the first data set and second data set includes at least one of:
a distribution type for values included in the first data set and values included in the second data set;
a pattern type for values included in the first data set and values included in the second data set; or
a value type for the values included in the first data set and values included in the second data set.

4. The storage medium of claim 1, wherein the output presentation type includes at least one of:
a graph displaying data that corresponds to values included in the first data set and values included in the second data set;
a mathematical result of mathematical combination of values included in the first data set and values included in the second data set; or
a clustering of values included in the first data set and values included in the second data set.

5. The storage medium of claim 1, wherein:
the second input includes a drag input that begins at a first location for the first input and ends at a second location for the second input; and
the output data replaces at least a portion of the first data set or at least a portion of the second data set.

6. A computing device for determining output presentation type, the computing device comprising:
a hardware processor; and
a data storage device storing instructions that, when executed by the hardware processor, cause the hardware processor to:
receive first input indicating selection of a first data set from a first file of a particular file type;
receive second input indicating selection of at least one other data set from at least one other file of the particular file type;
determine, based on at least one feature associated with the first data set and each of the at least one other data set, an output presentation type for output data; and
cause presentation of the output data according to the output presentation type.

7. The computing device of claim 6, wherein the output presentation type is determined based on at least one characteristic of the first input or at least one characteristic of the second input.

8. The computing device of claim 6, wherein the at least one feature of the first data set and each of the at least one other data set includes at least one of:
a distribution type for values included in the first data set and values included in the second data set;
a pattern type for values included in the first data set and values included in the second data set; or
a value type for the values included in the first data set and values included in the second data set.

9. The computing device of claim 6, wherein the output presentation type includes at least one of:
a graph displaying data that corresponds to values included in the first data set and values included in the second data set;
a mathematical result of mathematical combination of values included in the first data set and values included in the second data set; or
a clustering of values included in the first data set and values included in the second data set.

10. The computing device of claim 6, wherein the first data set and at least one other data set are included in a spreadsheet application operating on the computing device.

11. A method for determining output presentation type, implemented by a hardware processor, the method comprising:
receiving input indicating selection of at least two data sets from a particular source file, each of the at least two data sets including at least one value;
determining, based on at least one feature of the at least two data sets, an output presentation type for output data; and
causing presentation of the output data according to the output presentation type.

12. The method of claim 1, wherein the input includes a drag input that begins at a first location for one of the at least two data sets and ends at a second location for another of the at least two data sets.

13. The method of claim 1, wherein the at least one feature of the at least two data sets includes at least one of:
a distribution type for values included in the at least two data sets;
a pattern type for values included in the at least two data sets; or
a value type for the values included in the at least two data sets.

14. The method of claim 1, wherein the output presentation type includes at least one of:
a graph displaying data that corresponds to values included in at least two data sets;
a mathematical result of mathematical combination of values included in the at least two data sets; or
a clustering of values included in the at least two data sets.

15. The method of claim 1, wherein the at least two data sets are included in a spreadsheet application.
